(19) United States
(12) Patent Application Publication
(10) Pub. No.: US 2023/0004855 A1
(43) Pub. Date: Jan. 5, 2023

(54) CO-OPERATIVE AND ADAPTIVE MACHINE LEARNING EXECUTION ENGINES

(71) Applicant: Texas Instruments Incorporated, Dallas, TX (US)

(72) Inventors: Mihir Narendra MODY, Bengaluru (IN); Kumar DESAPPAN, Bengaluru (IN); Gregory Raymond SHURTZ, Houston, TX (US); Jason A.T. JONES, Richmond, TX (US)

(21) Appl. No.: 17/363,856

(22) Filed: Jun. 30, 2021

(51) Int. Cl. G06N 20/00; G06F 9/50

(52) U.S. Cl. CPC G06N 20/00; G06F 9/505

(57) ABSTRACT

Techniques for executing machine learning (ML) models including receiving an indication to execute an ML model on a processing core; determining a resource allocation for executing the ML model on the processing core; determining that a layer of the ML model will use a first amount of the resource, wherein the first amount is more than an amount of the resource allocated; determining that an adaptation may be applied to executing the layer of the ML model; executing the layer of the ML model using the adaptation, wherein executing the layer using the adaptation reduces the first amount of the resource used by the layer as compared to executing the layer without using the adaptation; and outputting a result of the ML model based on the executed layer.

### BACKGROUND

Machine learning (ML) is becoming an increasingly important part of the computing landscape. Machine learning is a branch of artificial intelligence (AI), and ML helps enable a software system to learn to recognize patterns from data without being directly programmed to do so. Neural networks (NN) are a type of ML which utilize a set of linked and layered functions (e.g., nodes, neurons, etc.) which are weighted to evaluate input data. In some NNs, sometimes referred to as convolution NNs (CNNs), convolution operations are performed in NN layers based on inputs received and weights rather than matrix multiplication used in traditional NN. Layers in CNNs may perform many types of functions, including, but not limited to, convolution, deconvolutional, pooling, up-sample, etc. CNNs are often used in a wide array of applications typically for recognition and classification, such as image recognition and classification, prediction and recommendation systems, speech and language recognition and translation, etc.

As ML becomes increasingly useful, there is a desire to execute complex ML techniques, such as NNs and CNNs, efficiently in devices with relatively limited compute and memory resources, such as embedded, or other low-power devices. To help efficiently run a given ML model, the ML model may be analyzed and optimized to tailor how the ML model is run to a target hardware resources to be used.

### SUMMARY

This disclosure relates to techniques for executing ML models, including receiving an indication to run an ML model on a processing core; determining a resource allocation for running the ML model on the processing core; determining that a layer of the ML model will use a first amount of the resource, wherein the first amount is more than an amount of the resource allocated; determining that an adaptation may be applied to executing the layer of the ML model; executing the layer of the ML model using the adaptation, wherein executing the layer using the adaptation reduces the first amount of the resource used by the layer as compared to running the layer without using the adaptation; and outputting a result of the ML model based on the executed layer.

Another aspect of the present disclosure relates to a non-transitory program storage device comprising instructions stored thereon to cause one or more processors to: receive an ML model, the ML model having one or more layers; simulate executing a layer of the ML model on a target hardware without an adaptation applied to determine a first adaptation criterion; simulate executing the layer of the ML model on the target hardware with the adaptation applied to determine a second adaptation criterion, wherein the adaptation reduces an amount of a resource used by the layer; determine that the adaptation may be applied to the layer based on a comparison of the first adaptation criterion and the second adaptation criterion and an adaptation threshold; and output an indication that the adaptation may be applied to the layer.

Another aspect of the present disclosure relates to an electronic device, comprising: a memory; and one or more processors operatively coupled to the memory, wherein the one or more processors are configured to execute instructions causing the one or more processors to: receive an indication to run an ML model on a processing core; determine a resource allocation for running the ML model on the processing core; determine that a layer of the ML model will use a first amount of the resource, wherein the first amount is more than an amount of the resource allocated; determine that an adaptation may be applied to executing the layer of the ML model; execute the layer of the ML model using the adaptation, wherein executing the layer using the adaptation reduces the first amount of the resource used by the layer as compared to running the layer without using the adaptation; and output a result of the ML model based on the executed layer.

### BRIEF DESCRIPTION OF THE DRAWINGS

For a detailed description of various examples, reference will now be made to the accompanying drawings in which:

FIG. 1 illustrates an example NN ML model, in accordance with aspects of the present disclosure.

FIG. 2 is a block diagram of a device, including hardware for executing ML models, in accordance with aspects of the present disclosure.

FIG. 3 is a timeline illustrating ML models executing across multiple computing cores, in accordance with aspects of the present disclosure.

FIG. 4 is a flowchart illustrating dynamic resource allocation, in accordance with aspects of the present disclosure.

FIG. 5 is a timeline illustrating ML model execution with adaptation across the computing cores, in accordance with aspects of the present disclosure.

FIG. 6 is a flowchart illustrating dynamic resource allocation with adaptation, in accordance with aspects of the present disclosure.

FIGS. 7A and 7B are bock diagrams illustrating precision adaptation, in accordance with aspects of the present disclosure.

FIG. 8 is a block diagram illustrating executing an ML model layer using data from external memory with memory adaptation, in accordance with aspects of the present disclosure.

FIG. 9 is a block diagram of a process for compiling ML models for target hardware, in accordance with aspects of the present disclosure.

FIG. 10 illustrates layer level dynamic resource usage information, in accordance with aspects of the present disclosure.

FIG. 11 is a flowchart illustrating a technique for determining adaptations for layers of an ML model, in accordance with aspects of the present disclosure.

FIG. 12 is a flowchart illustrating a technique for adapting execution of an ML model, in accordance with aspects of the present disclosure.

### DETAILED DESCRIPTION

As ML has becoming more common and powerful, hardware configured to execute ML models has been introduced. As used herein, an ML model may refer to an implementation of one or more ML algorithms which model a behavior, such as object recognition, behavior of a circuit, behavior of a neuron, etc. In cases where a target hardware for executing ML models is known, the ML models may be optimized for the target hardware configurations to help enhance performance. For example, ML models for object recognition, low-light enhancement, and facial recognition may be optimized to execute on a particular a mobile device, such as a smartphone configured with a certain ML processor. As another example, ML models for object recognition, movement prediction, and behavioral prediction may be optimized to execute on specific hardware found in certain partially or fully self-driving automobiles.

Example ML Model

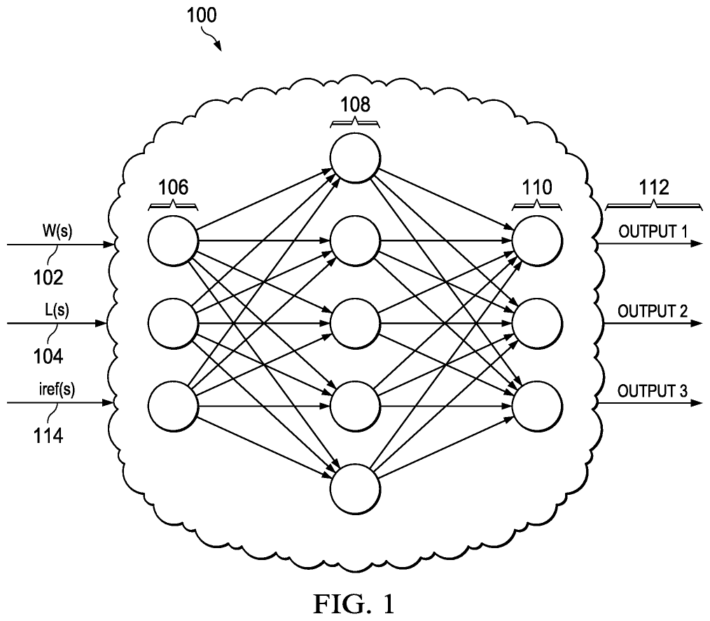

FIG. 1 illustrates an example NN ML model 100, in accordance with aspects of the present disclosure. The example NN ML model 100 is a simplified example presented to help understand how an NN ML model 100, such as a CNN, is structured and trained. Examples of NN ML models may include LeNet, Alex Net, Mobilnet, etc. It may be understood that each implementation of an ML model may execute one or more ML algorithms and the ML model may be trained or tuned in a different way, depending on a variety of factors, including, but not limited to, a type of ML model being used, parameters being used for the ML model, relationships as among the parameters, desired speed of training, etc. In this simplified example, parameter values of W, L, and iref are parameter inputs 102, 104, and 114, which are passed into the ML model 100. Each layer (e.g., first layer 106, second layer 108, and third layer 110) includes a plurality of nodes (e.g., neurons) and generally represents a set of operations performed on the parameters, such as a set of matrix multiplications, convolutions, deconvolutions, etc. For example, each node may represent a mathematical function that takes, as input (aside from the nodes of the first layer 106), output from a previous layer and a weight. The ML model outputs 112 are output from the last layer (e.g., the third layer 110). The weight is typically adjusted during ML model training and fixed after the ML model training. The specific mathematical function of the node can vary depending on ML model implementation. While the current example addresses three layers, in certain cases the ML model may include any number of layers. Generally, each layer transforms M number of input parameters to N number of output parameters. The parameter inputs to the first layer 106 are output as inputs to the second layer 108 with a set of connections. As each node of a layer (such as first layer 106) outputs to each node in a subsequent layer (such as second layer 108), ML model 100 is a fully connected NN. Other embodiments may utilize a partially connected NN or another NN design which may not connect each node of a layer to each node of a subsequent layer, where some node connections may skip layers, where no feedback is provided from output to inputs (e.g., Feed Forward CNN), etc.

In this example, first layer 106 represents a function based on a set of weights that are applied to the input parameters (e.g., input parameters 102 and 104) to generate output from first layer 106 that is input to the second layer 108. Different weights may be applied for the input received from each node of the previous layer by the subsequent layer. For example, for a node of the second layer 108, the node applies weights to input received from nodes of the first layer 106 and the node may apply a different weight to input received from each node of the first layer 106. Nodes compute one or more functions based on the inputs received and corresponding weights and outputs a number. In some cases, inputs and output to an ML model layer may be referred to as input or output features of the ML model layer. For example, the node may use a linear combination function which multiplies an input values from a node of the previous layer with a corresponding weight and sums across the results of the multiplication, coupled with a non-linear activation function which acts as a floor for the resulting number for output. It may be understood that any known weighted function may be applied by the node within the scope of this disclosure. This output number may be input to subsequent layers, or if the layer is a final layer, such as third layer 110 in this example, the number may be output as a result (e.g., output parameters or ML model outputs 112).

In some cases, the functions applied by nodes of a layer may differ as between layers. In some cases, each layer may have different resource requirements. For example, when the functions of multiple nodes are performed by a processor, the different functions may have different loads on the processor. Additionally, some functions may have different input or output parameters and thus consume more, or less, memory space and bandwidth. These differing processor and memory loads may also influence an amount of energy to power the processor and memory, as well as an amount of heat generated.

After an ML model, such as NN ML model 100, is defined with respect to nodes, layers, etc., the ML model may be trained. In some cases, the ML model 100 may be trained using a labelled data set corresponding to data to be input to ML model 100. For example, an object recognizer may be trained on images of objects. These images may include metadata labelling the object(s) in the image. The ML model 100 may be initiated with initial weights and the images input to the ML model 100 to generate predictions. The weights of the nodes may be adjusted based on how accurate the prediction is as compared to the labels. The weights applied by a node may be adjusted during training based on a loss function, which is a function that describes how accurately the predictions of the NN are as compared to the expected results; an optimization algorithm, which helps determine weight settings adjustments based on the loss function; and/or a backpropagation of error algorithm, which applies the weight adjustments back through the layers of the NN. Any optimization algorithm (e.g., gradient descent, mini-batch gradient descent, stochastic gradient descent, adaptive optimizers, momentum, etc.), loss function (e.g., mean-squared error, cross-entropy, maximum likelihood, etc.), and backpropagation of error algorithm (e.g., static or recurrent backpropagation) may be used within the scope of this disclosure.

In some cases, training the ML model 100 is performed during development of the ML model 100 and may be performed by a system or device separate from the system or device that runs the trained ML model.

Example Hardware for Executing ML Models

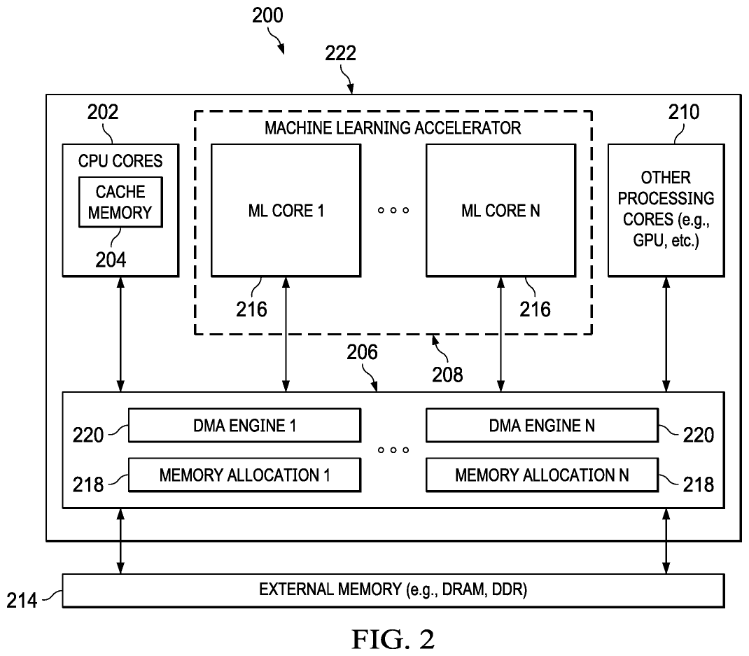

FIG. 2 is a block diagram 200 of a device, including hardware for executing ML models, in accordance with aspects of the present disclosure. The device may be system on a chip (SoC), including multiple components configured to perform different tasks. As shown, the device includes one or more central processing unit (CPU) cores 202, which may include one or more internal cache memories 204. The CPU cores 202 may be configured for general computing tasks.

The CPU cores 202 may be coupled to a crossbar (e.g., interconnect) 206, which interconnects and routes data between various components of the device. In some cases, the crossbar 206 may be a memory controller or any other circuit that can provide an interconnect between peripherals. Peripherals may include master peripherals (e.g., components that access memory, such as various processors, processor packages, direct memory access (DMA)/input output components, etc.) and slave peripherals (e.g., memory components, such as double data rate (DDR) random access memory, other types of random access memory, DMA/input output components, etc.). In some cases, the processing cores, such as CPU cores 202, ML accelerator 208, and other processing cores 210 and crossbar 206 may be integrated on a single chip, such as a SoC 222 with a separate external memory. In this example, the crossbar 206 couples the CPU cores 202 with other peripherals, such as an ML accelerator 208 and other processing cores 210, such as a graphics processing unit, radio basebands, coprocessors, microcontrollers, etc., and external memory 214, such as DDR memory, dynamic random access memory (DRAM), flash memory, etc., which may be on a separate chip from the SoC. The crossbar 206 may include or provide access to one or more internal memories that may include any type of memory, such as static random access memory (SRAM), flash memory, etc. The ML accelerator 208 may include one or more ML cores 216. The ML cores 216 may be processor cores configured to accelerate machine learning models and the ML cores 216 may include one or more internal caches (not shown).

In operation, such as when executing one or more ML models, the ML cores 216 may store and access data for executing the one or more ML models in a scratch memory to help improve performance, as compared to storing and accessing the data in the external memory 214. In some cases, an amount of data needed by the ML model varies based on the ML models. For example, the amount of data may vary based on the inputs and outputs of layers of the ML model, operations performed in the layers, number of nodes in the layers, etc. In some cases, an amount of scratch memory may be allocated for use by each executing ML model. In this example, the ML accelerator 208 may include N ML cores 216 executing N ML models with a corresponding N static memory allocations 218. The size of the memory allocations 218 may be fixed based on the ML model. The static memory allocations 218 may be made from the one or more internal memories included in or accessible via the crossbar 206.

To help facilitate the ML cores 216 and executing ML models access the memory allocations 218, the crossbar may include N DMA engines 220. In some cases, each DMA engine may be associated with a particular ML core 216. The DMA engines 220 may be used by applications, such as ML models, to perform memory operations and/or to offload memory management tasks from a processor. Of note, for simplicity, each ML core 216 is described as executing a single ML model, but it should be understood that any number of ML models may execute on any ML core 216, and these ML models may access a corresponding number of static memory allocations 218. In some cases, the DMA engines 220 along with sufficient scratch memory for the static memory allocations 218 may be integrated on the ML cores 216.

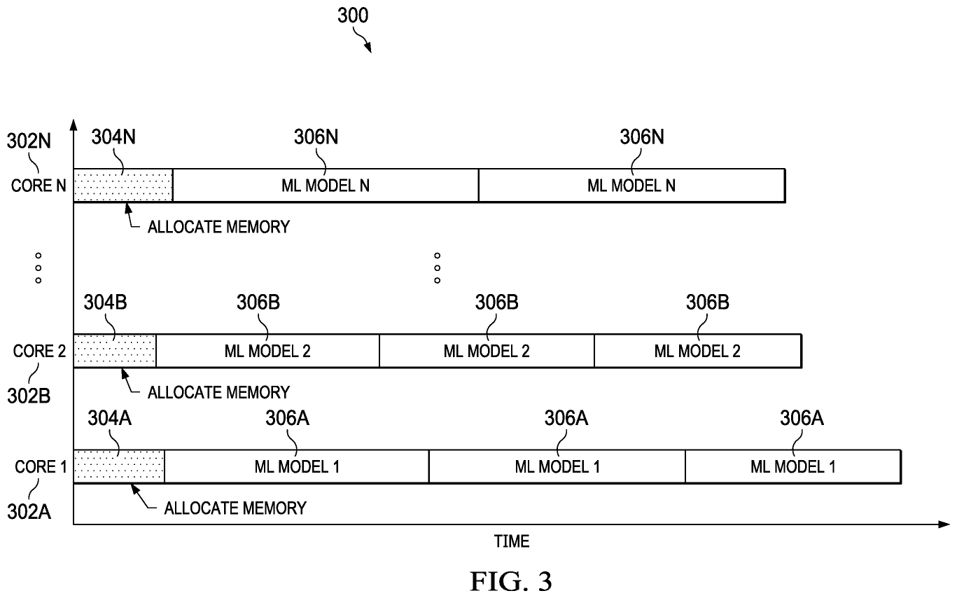

FIG. 3 is a timeline 300 illustrating ML models executing across multiple computing cores, in accordance with aspects of the present disclosure. The timeline 300 includes an X-axis plotting time and Y-axis plotting activities performed by the cores 302A, 302B, . . . 302n (collectively 302). In some cases, each of the cores 302 may be a general purpose CPU, an ML core, or other processor on which an ML model may be run. In some cases, core 302 may be a physical core or a logical core. In some cases, the ML core 302 on which an ML model 306 is executed may be determined prior to execution, for example during compilation process or during initialization, and may be static once determined. That is, the core 302 on which an ML model 306 is run does not change once the ML model 306 is initialized on the core 302 until ML model 306 execution is stopped. As shown, the ML model 306A may continue to run on a particular core 302A after initialization. In some cases, execution of multiple ML models may be optimized for target hardware during a compilation stage. Part of this optimization may include determining which cores particular ML models of the multiple ML models may execute on. In some cases, multiple ML models may be executed on a single core 302. Other ML models, such as ML models 306B . . . 406n, may be initialized and continue to run on other cores, such as cores 302B, . . . 302n. These ML models 306 may execute concurrently and asynchronously. That is, multiple ML models 306 may run at the same time without synchronization as between the ML models 306.

When initializing an ML model, such as ML model 306A, for execution, memory, such as a portion of the shared memory, may be allocated 304A for the ML model 306A prior to ML model 306A execution. The runtime code and parameters for the ML model may be stored in the static allocated memory 304 for use during ML model execution. As shown each executing ML model, such as 306A, 306B, . . . 306n may be associated with a static allocated memory space, such as 304A, 304B, . . . 304n, in the shared memory. A total size of the shared memory may then be based on a sum of the size of the static allocated memory spaces for the ML models to be run. In some cases, the size of the static allocated memory space for an ML model may be based on information obtained during the ML model compilation for the target hardware. In other cases, the size of the static allocated memory space for each ML model may be fixed.

In some cases, each layer of an ML model may be associated with different memory usage. For example, each layer may include a different number of nodes utilizing a different set of input parameters and different weights being applied for nodes of the layer, which influence the memory usage of the layer. In some cases, certain layers of an ML model, when executed, may use more memory than the memory available in the static memory. That is, an ML layer memory usage may exceed the size of the static allocated memory space (e.g., a static resource) for the ML model. In such cases, the ML model may be able to access dynamic resources of a target hardware. In the case of memory usage, the target hardware may be configured with dynamic memory (e.g., a common memory pool) that may be allocated to specific cores for use when executing ML model layers which use more memory than what is available in the static allocated memory space for the ML model.

Generally, the target hardware has a limited amount of resources that may be allocated among executing software, such as the multiple ML models. For example, the target hardware may have a certain amount of internal memory available, a certain amount of memory throughput and bandwidth available, and a certain amount of power that the target hardware can draw. In accordance with aspects of the present disclosure, an ML model executing on target hardware may be allocated a set of static resources for execution. In some cases, the static resources may include a certain amount of memory (e.g., the static allocated memory), a certain amount of memory throughput, a certain amount of memory bandwidth, and a certain amount of power/current for the core executing the ML model. If execution of the ML model requires additional resources, dynamic resources from a set of common (e.g., shared between multiple ML models and cores) on-demand resources may be allocated for the ML model as needed. In some cases, the dynamic resources may also include an amount of memory (e.g., dynamic memory), a certain amount of memory throughput, a certain amount of memory bandwidth, and a certain amount of power/current.

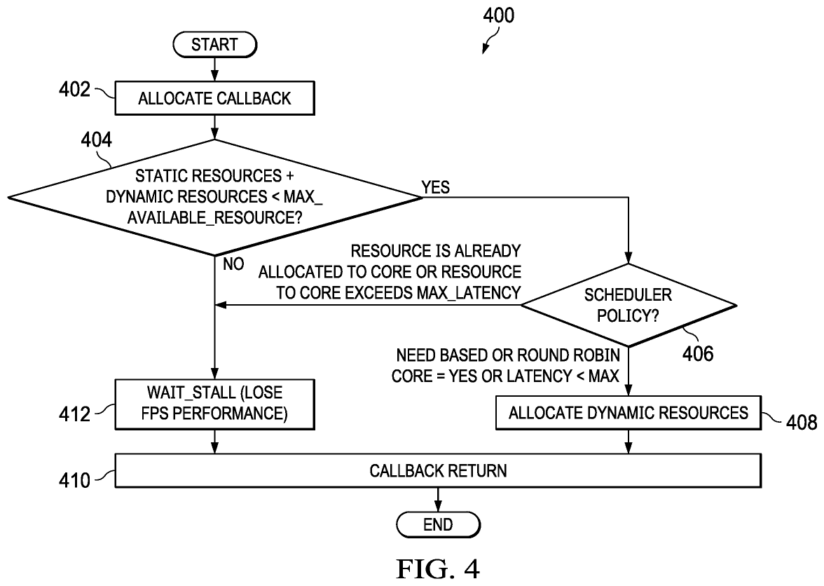

In some cases, when resources are dynamically allocated, the multiple ML models may attempt to access one or more dynamic resources. FIG. 4 is a flowchart 400 illustrating dynamic resource allocation, in accordance with aspects of the present disclosure. In some cases, a core may determine that a layer of an ML model may use more of a particular resource than has been statically allocated to the ML model for that core. For example, an amount of static and dynamic resources used by the layer of the ML model may be indicated in a common context associated with a set of ML model executing on the target hardware. After a determination is made that the layer of the ML model uses more of a resource than the static allocation, at block 402, a callback may be allocated. In some cases, dynamic allocations may be implemented via callback functions to help avoid possible task switching while the resources are being allocated. In some cases, callback functions may be implemented in a software function, such as the runtime code, and call into other external functionality. A callback may be executable code and/or functions passed as an argument into another function. For example, code for a dynamic allocation function may be passed as an argument of a function call. In some cases, parallel threads to threads used by the ML model may also be used. At block 404, the amount of the resource, both static and dynamic, requested by the layer of the ML model may be compared to a maximum available amount of the resource available. For example, if a portion of the dynamic resource is in use by another ML model, there may less of the dynamic resource available for allocation. If the amount of the resource requested is less than the amount of the dynamic resource available for allocation, then at block 406 the dynamic resource may be allocated based on a scheduler policy. In some cases, the scheduler policy may be a need-based or round-robin scheduler. In some cases, the latency may also be checked against a maximum latency. The maximum latency may be based on a maximum time an ML model may take to determine an output (e.g., inference). For example, where the ML model is expected to be used to process video in real time, the maximum latency may be set such that the ML model can be executed within an amount of time available between frames of the video. At block 408, the dynamic resources are allocated. In some cases, allocating the dynamic resource may be performed using atomic operations. At block 410, the callback allocation returns. In some cases, the dynamic resource requested may already be allocated to the core. For example, another ML model executing on the core may be using the dynamic resource. In such cases, execution may proceed to block 412 where execution of the layer of the ML model may stall until the dynamic resource becomes available. Returning to block 404, if the amount of the resource requested is more than the amount of the dynamic resource available for allocation, then execution may proceed to block 412 where execution of the layer of the ML model may stall until the dynamic resource becomes available.

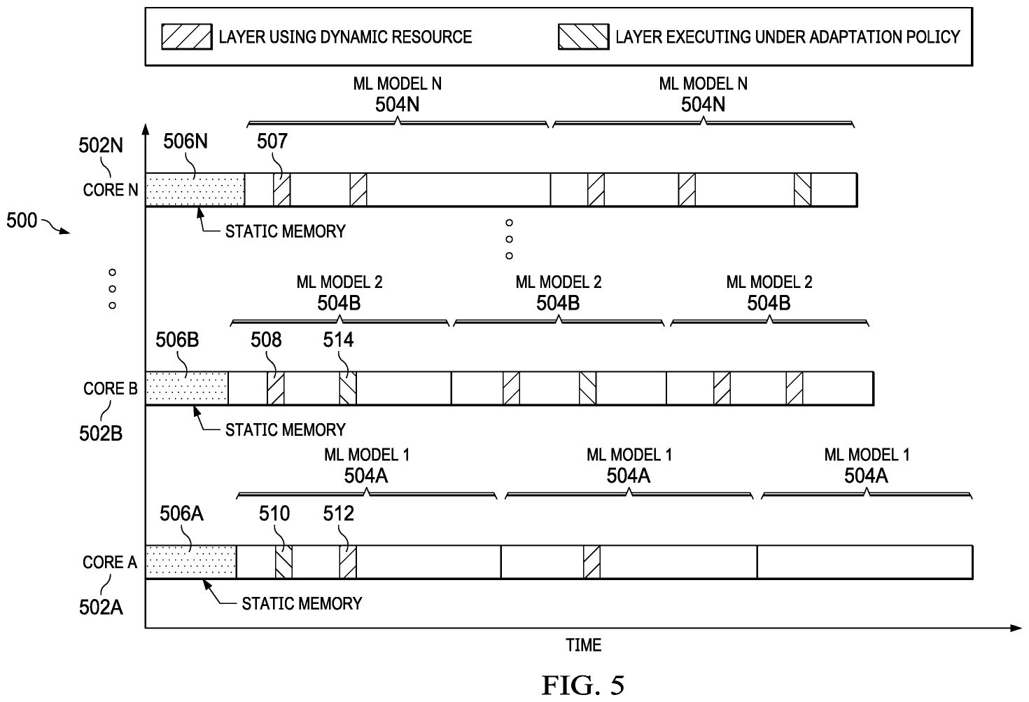

In some cases, to help avoid stalling execution of an ML model, execution of the ML model may be adapted based on an adaptation policy. FIG. 5 is a timeline 500 illustrating ML model execution with adaptation across the computing cores, in accordance with aspects of the present disclosure. The timeline 500 includes an X-axis plotting time and Y-axis plotting activities performed by the cores 502A, 502B, . . . 502N (collectively 502). In some cases, the cores 502 may be physical general purpose CPUs, ML cores, or other processors on which ML models may be run. In some cases, cores 502 may be mapped to logical cores. As shown in this example, each core 502 is shown executing an ML model 504, with core 1 502A executing ML model 1 504A, core 2 502B executing ML model 2 504B, and core n executing ML model n 504N. Prior to executing the ML models 504, each core is allocated a static memory 506, with core 1 502A being allocated static memory 506A, core 2 502B being allocated static memory 506B, and core n 502N being allocated static memory 506N. In some cases, each static memory 506 may be a different size.

In some cases, a layer, such as a first layer 507 of ML model N 504N, may use more memory than available in the static memory 506N. In such cases, the first layer 507 may execute using dynamic resources (e.g., dynamic memory). Similarly, a second layer 508 of the ML model 2 502B may also execute using dynamic resources. A third layer 510 of ML model 1 504A may also use more memory than available in the static memory 506A and may attempt to access dynamic resources. In this case, as dynamic resources have been allocated to the first layer 507 and the second layer 508, there may be insufficient dynamic resources to allocate to the third layer 510. In such cases, the third layer 510 may execute under an adaptation policy that alters (e.g., adapts) the execution of the third layer 510. In some cases, not every layer of an ML model may be capable of executing under the adaptation policy. For example, a fourth layer 512 of ML model 1 504A may not be capable of executing under the adaptation policy and may be allocated dynamic resources. A fifth layer 514 of ML model 2 504B may instead be executing under the adaptation policy.

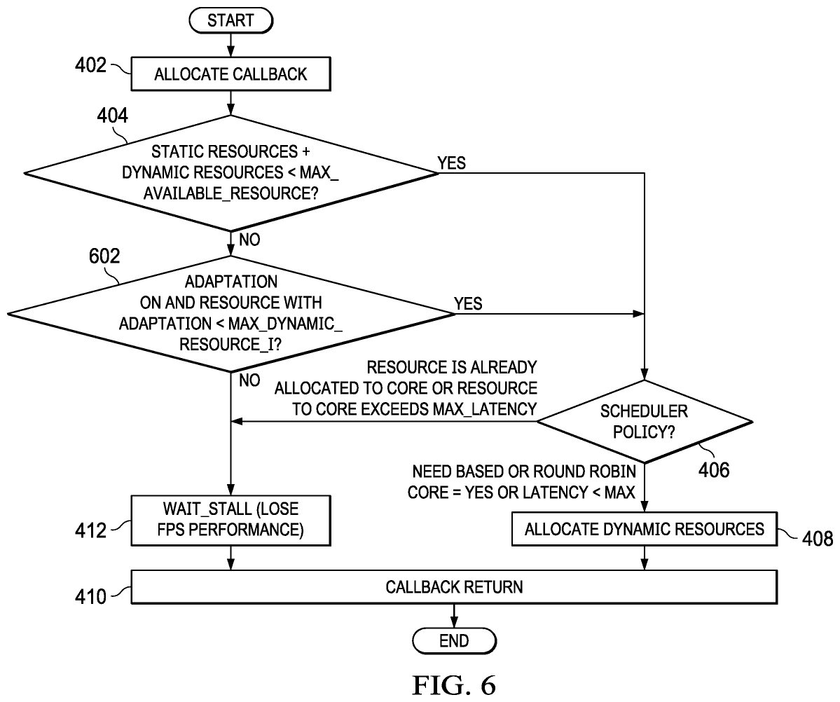

FIG. 6 is a flowchart 600 illustrating dynamic resource allocation with adaptation, in accordance with aspects of the present disclosure. As shown, flowchart 600 is similar to flowchart 400 shown in FIG. 4. After the comparison of the availability of requested static and dynamic resources against the maximum available amount of the resource available at block 404, an adaptation policy may be implemented at block 602. At block 602, an amount of the resource, both static and dynamic, that would be used with an adaptation policy implemented is compared to the maximum available amount of the resource available. For example, the common context associated with the ML models may include information indicating an amount of the resource the layer of the ML model would use if an adaptation policy is implemented. As a more detailed example, if an amount of internal memory throughput used by a layer of the ML model is achieved by executing the layer using whole and/or contiguous memory banks of the internal memory and a size of the input features exceeds the size of the whole and/or contiguous memory banks available, the size of the input features under an adaptation policy (e.g., lower precision input features) may be determined. This determination may be made based on information in the common context or determined based on a size of the stored (e.g., in external memory) lower precision input features. This amount of the resource used under the adaptation policy may be compared to the amount of the static and dynamic resource available for allocation to the layer. For example, the size of the lower precision input features may be compared to the size of the whole and/or contiguous memory banks available.

If the amount of the resource under the adaptation policy is less than the amount of the static and dynamic resource available for allocation to the layer, execution proceeds to block 406 as described above in conjunction with FIG. 4, where the dynamic resource may be allocated based on a scheduler policy. If the amount of the resource under the adaptation policy is more than the amount of the static and dynamic resource available for allocation to the layer, execution proceeds to block 412 where execution of the layer of the ML model may stall until the dynamic resource becomes available.

In some cases, the adaptation policy may include various possible alterations to the execution of an ML model layer. These alterations may be used to help reduce the amount of resources of the target hardware used by layers of the ML model. For example, an amount of power/current used by a layer may be adapted by reducing the speed at which the layer is executed on the core and/or executing the layer on a more power-efficient core. Where executing a particular layer on a first core may cause the first core to use more than a certain amount of power (either from executing the particular layer, or in combination with another executing ML model), execution of the particular layer may be adapted by reducing the speed at which the layer is processed by the core, for example, by adjusting the clock of the core or by inserting waits between instructions associated with the layer. In some cases, when executing a particular layer on a first core may cause the first core to use more than a certain amount of power, the particular layer may be executed on a second core. The second core may be a more power-efficient core and/or may be a different type of processing core. For example, the layer may be executed on a digital signal processor (DSP) core rather than an ML core. In some cases, a second, more power-efficient core may be associated with a reduced performance as compared to the first core. Executing the layer using an adaptation policy which adapts the amount of power/current used by the layer helps avoid having to stall the execution of the layer, for example, to reduce power usage to stay within a power and/or thermal budget. Adapting the amount of power/current may result in reduced performance for the layer and the overall ML model but avoids stalling, and thus stopping, execution of the layer entirely for a period of time.

As another example, an amount of memory, an amount of memory throughput, and an amount of memory bandwidth used by a layer may be adapted by adjusting weight and/or input/output feature precision and/or by directly executing the ML model layer in external memory.

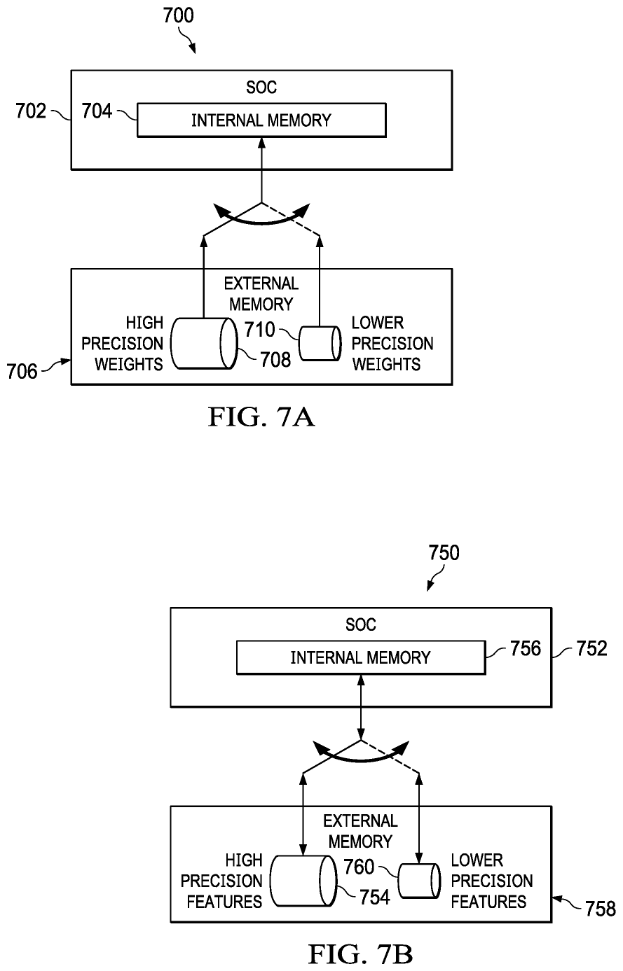

FIGS. 7A and 7B are bock diagrams illustrating precision adaptation, in accordance with aspects of the present disclosure. Diagram 700 of FIG. 7A includes an SoC 702 with an internal memory 704. In some cases, the SoC 702 may include one or more processing cores along with one or more internal memories 704. In some cases, the SoC 702 may be organized as described with respect to SoC 222. The internal memory 704 may include one or more cache or scratch memories. The SoC 702 may be coupled to an external memory 706. The external memory 706 may include information associated with one or more ML models to be executed on a core of the SoC 702. The information associated with an ML model may include runtime code and parameters for the ML model. The parameters for the ML model may include information that may be dynamically loaded from memory for executing the ML model, such as weights, layer ordering information, structure, memory needed to store data input/output between layers, etc.

A layer of an ML model may receive a set of input features which may be input into nodes of the layer. The nodes of the layer may then determine a function based on one or more features input into the node along with one or more weights input into the node. The determined results of the function for the node may be output as a part of an output feature of the layer. In some cases, the weights and features may be associated with a particular bit precision. For example, the weights for the layer may be in the form of a 16-bit float representing a number between 0 and 1. The number of bits representing the weights and features is associated with a level of precision that is able to be represented. For example, 8-bits can represent up to 256 different values, while 16-bits can represent up to 65,536 different values. However, for certain layers, a difference between the number of values that can be represented by the bits representing the weights and features may not be representative of a difference in the quality of the output of the layer. That is, there may be a negligible difference in the quality of the output of certain layers (and ML model as a whole) if the bit value, and hence precision, of the bits representing the weights for the layer are reduced. For example, layers with relatively large weight values often can be quantized into lower bit values as there is often a larger difference between weight values of the layer.

In some cases, after training of an ML model, weights may be associated with the layers of the ML model. These weights may be considered the high-precision weights 708. The bit precision of weights associated with a layer may be reduced, for example, by quantizing (e.g., bucketing) bit values associated with the higher number of bits into equally spaced value buckets based on the values available in the lower bit rate. Layers in where the bit precision of the weights can be reduced with a negligible difference in quality may be identified during a compilation/preparation process of the ML model for the target hardware. The lower-precision weights 710 for a layer may be generated from the high-precision weights 708 as a part of the compilation/preparation process for those identified layers. For example, weights for the layer may then be quantized from the set of high-precision weights 708 into weights for a set of lower-precisions weights 710. In some cases, each identified layer of the ML model on which lower-precision weights 710 have a negligible impact on may have lower-precision weights generated for that layer. These lower-precision weights 710 may be stored in the external memory 706. When an adaptation policy is used for a layer, these lower-precision weights 710 may be loaded from the external memory 706 to the internal memory 704 for use in the ML model. The adaptation policy using lower-precision weights 710 may help reduce an amount of internal memory 704, reduce an amount of memory throughput of the internal memory 704, as well as reduce an amount of bandwidth as between the external memory 704 and the SoC 702 used to process the layer of the ML model.

Features of an ML model may refer to inputs and outputs of a layer of the ML model. For example, a set of input features, which may represent aspects of a part of an image for a recognizer type ML model, may be input into a first layer of the ML model. This first layer may then output a set of output features. This set of output features then may be input as a set of input features to a second layer of the ML model. In some cases, a bit precision of the input features or output features may also be reduced. Layers in where the bit precision of the input features or output features can be reduced with a negligible difference in quality may be identified during a compilation/preparation process of the ML model for the target hardware.

As shown in diagram 750 of FIG. 7B, a layer of an ML model may execute on a SoC 752. In a first example, the layer may execute using high-precision features 754 loaded into the internal memory 756 from external memory 758. The layer of the ML model may then be adapted to output either a set of high-precision output features 754 or a set of lower-precision features 760 to external memory 758 based on the adaption policy. The output high-precision output features 754 may be used to output a set of lower-precision features 760, for example, by quantizing the output high-precision output features 754 into a set of lower-precision features 760. Where the adaptation policy is in place for a next layer, the lower-precision features 760 may be generated and output to external memory 758 instead of the high-precision output features 754. The output high-precision output features 754 or lower-precision features 760 may be then stored in the external memory 758.

In a second example, the layer of the ML model may execute on SoC 752 using lower-precision features 760 loaded into the internal memory 756 from external memory 758. For example, a previous layer of the ML model may have output lower-precision features 760. Where the adaptation policy is used for the current layer, the lower-precision features 760 may be loaded from the external memory 758 to the internal memory 756 for use by the current layer. The adaptation policy using lower-precision features 760 may help reduce an amount of internal memory 756, reduce an amount of memory throughput of the internal memory 756, as well as reduce an amount of bandwidth as between the external memory 758 and the SoC 752 used to process the layer of the ML model.

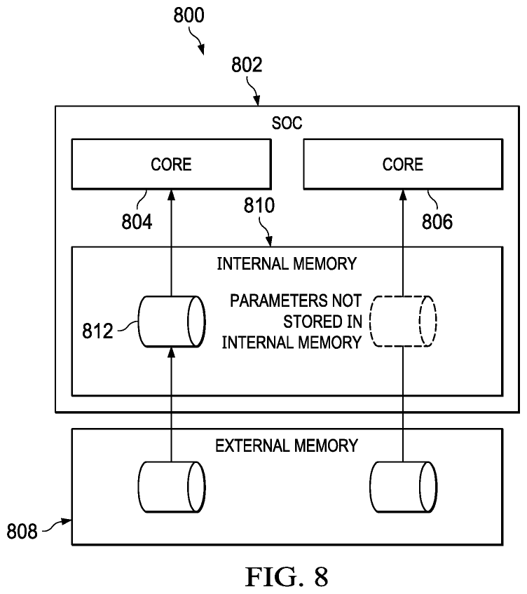

In some cases, under an adaptation policy, an ML model layer may execute using data directly from external memory. FIG. 8 is a block diagram 800 illustrating executing an ML model layer using data from external memory with memory adaptation, in accordance with aspects of the present disclosure. As shown in diagram 800, a SoC 802 may include multiple cores 804 and 806 executing ML models. In some cases, when an ML model is executed without using an adaptation policy, parameters associated with the ML model, such as weights, layer ordering information, structure, features, etc., may be loaded (e.g., staged) from external memory 808 into a portion 812 of internal memory 810 prior to use by the ML model executing on core 804. The ML model then accesses the weights, features, etc., from the portion 812 of internal memory 810 when running. In some cases, the ML model layer may directly use external memory 808 to access the parameters associated with the ML model, rather than loading these parameters from external memory 808 into the portion 812 of the internal memory 810. For example, such an adaptation may be used to reduce an amount of internal memory 810 used to process the layer of the ML model. This adaptation may also be used to reduce an internal memory throughput used to process the layer of the ML model. While this adaptation may result in reduced performance for the layer and the overall ML model, this adaptation avoids stalling, and thus stopping, execution of the layer entirely for a period of time.

ML Model Compilation

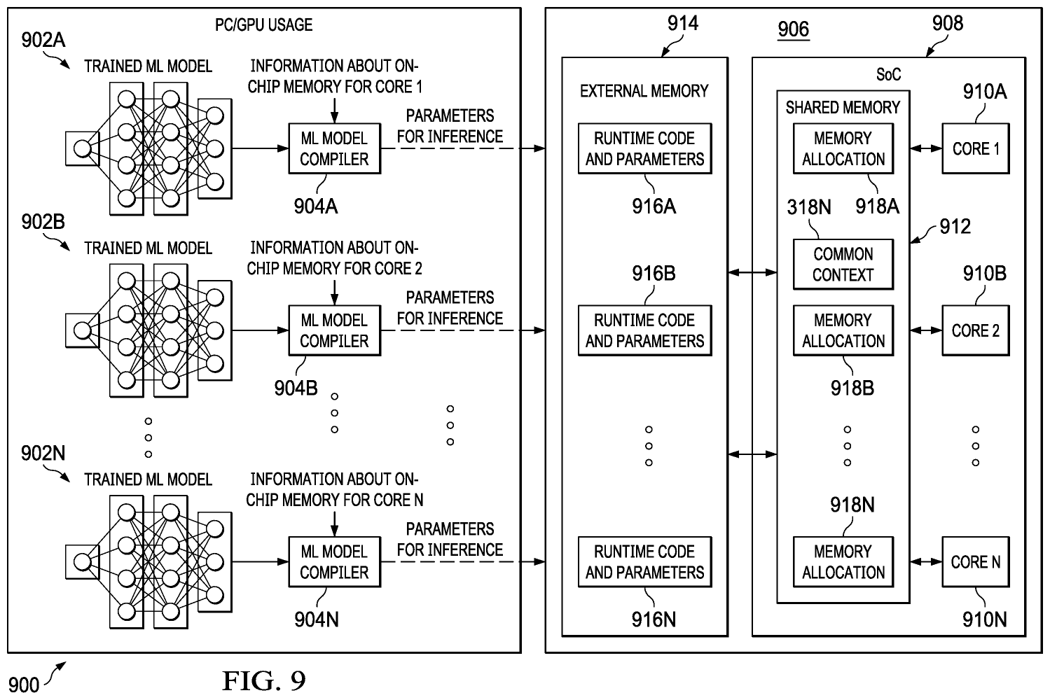

FIG. 9 is a block diagram 900 of a process for compiling ML models for target hardware, in accordance with aspects of the present disclosure. Machine learning models 902A, 902B . . . 902n (collectively 902) are trained during a training phase of development of the respective ML model 902. Training an ML model 902 teaches the ML model 902 to perform a task. For example, an ML model 902 for object recognition may be trained by presenting the ML model 902 with labeled images, including an object, letting the ML model 902 attempt to identify the object in the image, and then adjusting parameters of the ML model 902, such as weights for layers of the ML model 902, based on how well the ML model 902 recognized the object.

Once an ML model 902 is trained, the ML model 902 may be compiled and/or prepared for a target hardware by an ML model complier 904A, 904B, . . . 904n (collectively). It may be understood that the compilation process may include multiple processes, steps, operations, etc., which may be performed separately, and/or in an automated fashion. In this example, the target hardware 906 is shown as a simplified version of the device shown in FIG. 2, and the target hardware 906 includes a SoC 908 with one or more cores 910A, 910B, . . . 910n coupled to a shared memory 912. The SoC 908 is also coupled to external memory 914. The ML model compiler 904 helps prepare the ML model 902 for execution by the target hardware 906 by translating the ML model 902 to a runtime code and parameters 916A, 916B, . . . 916n (collectively 916) that is compatible with the target hardware 906.

It may be understood that the compilation process may include multiple sub-processes. For example, in addition to translating the ML model 902 to runtime code, the compilation process may also include one or more sub-processes analyzing execution of the ML model 902 on the target hardware. In cases with multiple ML models 902 executing on multiple cores 910, the ML model compiler 904 may determine which core 910 an ML model 902 should run on. The ML model compiler 904 may also parameterize the ML model 902 being compiled. In some cases, the ML parameters may include information that may be dynamically loaded from memory for executing the ML model 902, such as weights, layer-ordering information, structure, memory needed to store data input/output between layers, etc.

As shown, trained ML models 902 may be compiled and/or translated for a target hardware by an ML model complier 904. In some cases, simulations may be performed after the ML model is trained and as a part of preparing the trained ML model 902 for execution on the target hardware 906. For example, as a part of the compilation and/or translation process, ML model execution on the target hardware 906 may be simulated. In some cases, the simulation of the ML model execution may be performed as a separate process from the compilation/translation process.

In some cases, the simulation may be repeated with a number of variations of certain constraints, such as with various amounts of available dynamic memory available to be allocated for the cores. In some cases, these simulations may help determine which layers of the ML model 902 may be adapted. Layers of the ML model 902 may be simulated executing on the target hardware with one or more adaptation applied. For example, layers of the ML model 902 may be simulated executing on the target hardware with high-precision weights as well as lower-precision weights to analyze an impact the lower-precision weights have on the overall quality of the ML model. Layers associated with a negligible impact on quality may be identified as layers on which a weight-precision adaptation policy may be applied. For example, output features of a simulated layer using lower-precision weights may be compared to output features of a simulated layer using high-precision weights. If the difference is below a certain threshold, then the layer may be identified as supporting the weight-precision adaptation policy. As another example, output features of the ML model using lower-precision weights for a layer may be compared to output features of the ML model using higher-precision weights for the layer. If the difference is below a certain threshold, then the layer may be identified as supporting the weight-precision adaptation policy. In some cases, each layer of the ML model 902 may be simulated with and without one or more adaptations applied. In other cases, a subset of the layers of the ML model 902 may be simulated with one or more adaptations applied. For example, the layers which use more of a resource than the static allocation of the resources may be simulated with one or more adaptations applied.

Similarly, the layers of the ML model 902 may be simulated executing on the target hardware with high-precision features as well as lower-precision features to help determine which layers of the ML model 902 may be adapted. For example, layers of the ML model 902 may be simulated executing on the target hardware with high-precision features as well as lower-precision features to analyze an impact the lower-precision features have on the overall quality of the ML model. Layers associated with a negligible impact on quality may be identified as layers on which a feature-precision adaptation policy may be applied. For example, output features of the ML model using lower-precision features for a layer may be compared to output features of the ML model using higher-precision features for the layer. If the difference is below a certain threshold, then the layer may be identified as supporting the feature-precision adaptation policy.

Similarly, the layers of the ML model 902 may be simulated for adaptation policies where the amount of power/current used by a layer may be adapted by reducing a speed at which the layer is executed on the core, executing the layer on a more power-efficient core, and/or executing the ML model layer using data from external memory. For example, layers of the ML model 902 may be simulated with and without one or more of the adaptations active to determine an impact the adaptation has on ML model execution speed, frames per second, latency, power usage, etc. These impacts may be compared to thresholds to determine whether to identify the layer as one on which a corresponding adaptation may be applied.

After the layers on which an adaptation may be applied are identified, an indication of these layers and what adaptation may be applied may be stored as a part of the runtime code and parameters 916 associated with the ML model. In some cases, portions of the runtime code and parameters 916 may be loaded into a common context 920 in the shared memory 912.

After compilation of the ML model 902 to runtime code 916 for the target hardware 906, the parameters of the ML model 902 may be stored, for example, in the external memory 914. When an ML model 902 is executed, portions of the runtime code and parameters 916 may be loaded, for example, into a static memory allocation 918 in shared memory 912 or other memory. In some cases, a particular ML model 902 may be executed by a particular ML core 910 of the ML cores 910. Multiple ML models may be executed concurrently across the multiple ML cores. In some cases, certain ML models may be designated to execute on certain cores of the target hardware.

In some cases, resources used by the layers of the ML models may also be determined as a part of the compilation process. As a part of simulations of the ML model executing on the target hardware, resource use of the target hardware may be monitored on a per-layer basis for the ML models. This layer resource usage information may be stored, for example, in the runtime code and parameters 916 and loaded as a part of the common context 920 upon ML model execution. In some cases, the layer resource usage information may be relative to the static resources. For example, the layer resource usage information may indicate cases in which a respective layer uses more of a resource than a static allocation of the resource to a core.

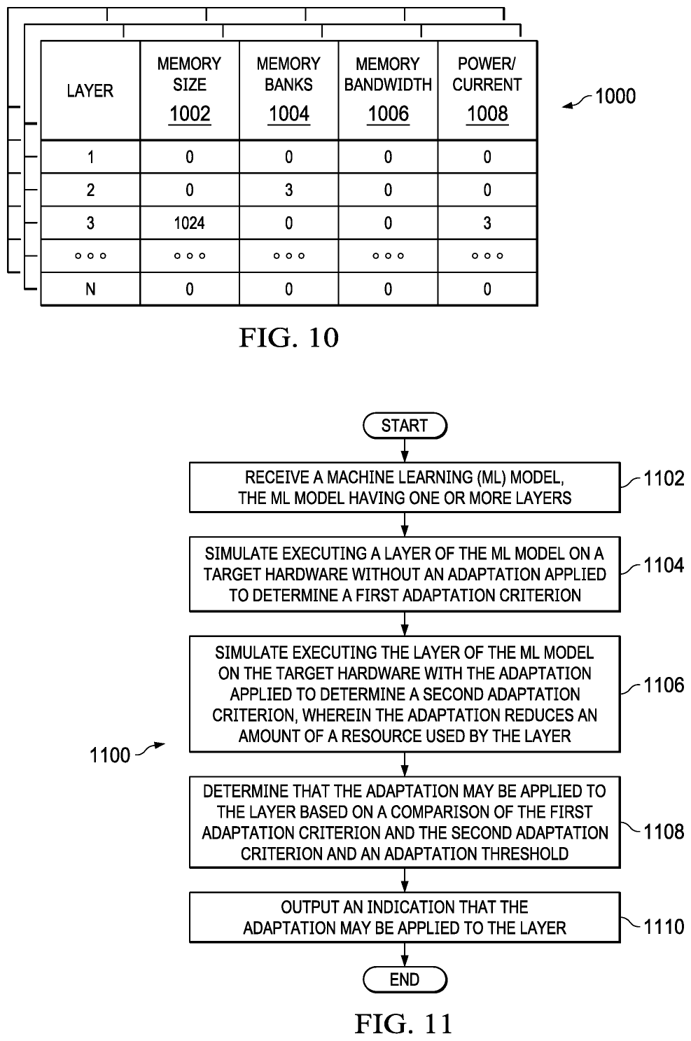

FIG. 10 illustrates layer-level dynamic resource usage information 1000, in accordance with aspects of the present disclosure. In this example, usage information for four resources may be recorded for each layer of a set of ML models. The resources include an amount of memory 1002 used by the ML model layer, a number of memory banks 1004, indicating a measurement of internal memory throughput, used by the ML model layer, a memory bandwidth usage 1006 by the ML model layer, and an amount of power/current 1008 used by the ML model layer. As shown in FIG. 10, the amounts may be relative to static resources. For example, a 0 value indicates that for a layer, an amount of that resource used by the layer does not exceed the static allocation of the resource for the core on which the ML model layer is executing. Non-zero values indicate a number of units of the resource that the layer uses in addition to the static allocation of the resource. That is, non-zero values indicate an amount of a dynamic allocation of the resource used for the layer. Thus, layer 3 may use an additional 1024 bytes of memory in addition to the static allocated memory space along with 3 additional mA of current in addition to the static allocated current for the core for executing the ML model layer. In some cases, additional resource usage information for layers may be generated indicating resource usage with certain adaptations applied.

In some cases, the additional resource usage information may be stored as a part of the context information. In some cases, the additional resource information may be used to generate one or more adaptation policies. For example, the additional resource information generated with different (and/or different combinations) adaptations applied may be combined with information related to the impact the adaptation has on ML model, such as execution speed, frames per second, latency, power usage, etc. to determine one or more adaptation policies. As a more detailed example, if a layer under a first adaptation, such as weight/feature precision adaptation, uses more of the resource than a second adaptation, such as an adaptation where the layer is executed from external memory, but executes at a higher speed under the first adaptation, the first adaptation may be used as a part of a first adaptation policy and the second adaptation may be used as part of a second adaptation policy. These adaptation policies may be determined as a part of the compilation process and during execution of the ML model, either the first or the second adaptation policies may be applied based on the resources available during execution. For example, where more of the resource is available for dynamic allocation, then the first adaptation policy may be applied to help maintain execution speed with the adaptation policy applied. Where less of the resource is available for dynamic allocation, then the second adaptation policy may be applied to help allow the layer to be executed, rather than stalled.

FIG. 11 is a flowchart 1100 illustrating a technique for determining adaptations for layers of an ML model, in accordance with aspects of the present disclosure. At block 1102, an ML model is received, the ML model having one or more layers. For example, a device configured to prepare ML models to execute on a target hardware may receive an ML model, such an NN ML model. At block 1104, a layer of the ML model is simulated executing on a target hardware without an adaptation applied to determine a first adaptation criterion. For example, layers of the ML model may be simulated executing on the target hardware without adaptions applied. This helps establish a baseline measurement of resources used by layers of the ML as well as performance of the layers of the ML model, such as a number of times the ML model or layer may be executed per second, how long layers take to run, etc., output feature values of the layer, and overall output of the ML model.

At block 1106, the layer of the ML model is simulated executing on the target hardware with the adaptation applied to determine a second adaptation criterion, wherein the adaptation reduces an amount of a resource used by the layer. For example, layers of the ML model may be simulated with one or more adaptations applied. The resources used as well as performance of the layers of the ML with adaptations applied may be determined.

At block 1108, a determination that the adaptation may be applied to the layer based on a comparison of the first adaptation criterion and the second adaptation criterion, and an adaptation threshold is made. For example, the performance of layers of ML with adaptations applied are compared to the performance of corresponding layers of the ML without adaptations applied. As a more detailed example, for adaptations which alter the bit precision of the features and/or weights of the layer, a difference between output feature values and/or output of the ML model executed with and without the adaptation applied to the layer may be compared to a threshold to determine that the adaptation has a negligible affect on the ML model and that the adaptation may be applied to the layer. As another example, for the adaptation which slows down execution of the layer on the processing core, executes the layer on another processing core, or executes the layer from external memory, a performance of the layer, such as a number of times the ML model or layer may be executed per second, how long layers take to run, etc. may be determined in context with one or more other ML models simulated executing on the target hardware. This, in turn, may cause layers of the ML model to be stalled waiting for access to one or more resources, thus reducing the performance of layers of the ML model. The ML model may then be simulated, in context with one or more other ML models with one or more adaptation applied, to determine the performance of the layer with adaptations. The performance of the layer with adaptations are then compared to the performance of the layer without adaptations to see if the performance of the layer with adaptations performs at least a threshold amount better than the performance of the layer without adaptations. In some cases, this threshold may be that there is some improvement. If there is at least a threshold amount of performance improvement, a determination is made that adaptation may be applied to the layer. In some cases, steps 1104-1108 may be repeated for the layers of the ML model using different adaptations and/or combinations of adaptations. In some cases, these steps may be repeated exhaustively for the layers of the ML and available adaptations.

At block 1110, an indication that the adaptation may be applied to the layer is output. For example, an indication of which adaptations may be applied to which layers may be output as a part of the runtime code and parameters associated with the ML model.

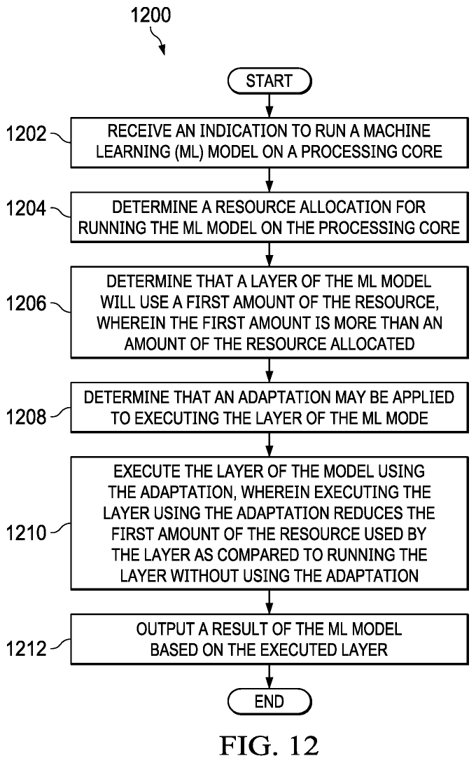

FIG. 12 is a flowchart 1200 illustrating a technique for adapting execution of an ML model, in accordance with aspects of the present disclosure. At block 1202, an indication to run an ML model on a processing core is received. For example, a device configured to execute ML models, such as an NN, receives an ML model to execute. The ML model may be associated with runtime code and parameters which indicate layers of the ML to which certain adaptations may be applied. At block 1204, a resource allocation for running the ML model on the processing core is determined. For example, a set of static resources may be allocated to the processing core executing the ML model. At block 1204, a determination that a layer of the ML model will use a first amount of the resource is made. The first amount is more than an amount of the resource allocated. For example, portions of the runtime code and parameters may indicate an amount of resources used by layers of the ML model. In some cases, this information may be loaded into a common context prior to execution of the ML model. In some cases, an amount of one or more resources used by the ML model may exceed the static allocation of the resources. At block 1206, a determination is made that an adaptation may be applied to executing the layer of the ML model. For example, the parameters (and/or context information) associated with the ML model may indicate which adaptations may be applied to which layers. In some cases, where the amount of a resource used by the layer of the ML model exceeds the static allocation of the resource, the amount of the used is compared to an amount of the resource statically allocated and an amount of the resource available for dynamic allocation. If the amount of the resource used by the layer of the ML model exceeds the amount of the resource statically allocated and the amount of the resource available for dynamic allocation, the adaptations applicable to the layer for the resource may be applied. At block 1208, the layer of the ML model is executed using the adaptation, wherein executing the layer using the adaptation reduces the first amount of the resource used by the layer as compared to running the layer without using the adaptation. In some examples, the determinations of blocks 1204 and 1206 are made while the layer of the ML model is being executed by the respective processing core, and thus adaptations may be determined and implemented during the execution of block 1208 with execution continuing uninterrupted. At block 1210, a result of the ML model, based on the executed layer, is output.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Modifications are possible in the described embodiments, and other embodiments are possible, within the scope of the claims.

What is claimed is:

1. A method, comprising:
receiving an indication to execute a portion of a machine learning (ML) model on a processing core;
determining a resource allocation for executing the ML model on the processing core;
determining that a layer of the ML model will use a first amount of a resource that causes the resource allocation to be exceeded;
determining that an adaptation may be applied to executing the layer of the ML model;
executing the layer of the ML model using the adaptation, wherein executing the layer using the adaptation reduces the first amount of the resource used by the layer as compared to executing the layer without using the adaptation; and
outputting a result of the ML model based on the executed layer.

2. The method of claim 1, wherein determining that the layer of the ML will use the first amount of the resource comprises:
receiving a request, from the processing core executing the ML model, for a dynamic allocation of a second amount of the resource; and
determining that there is an insufficient amount of the resource to allocate the second amount to the processing core.

3. The method of claim 2, wherein the resource is dynamically allocated to another executing ML model.

4. The method of claim 1, wherein the resource comprises one of an amount of memory, an amount of memory bandwidth, an amount of memory throughput, and an amount of current.

5. The method of claim 1, wherein the adaptation comprises at least one of:
altering a number of bits used to represent features of the layer;
altering a number of bits used to represent weights of the layer;
executing the layer on another processing core;
executing the layer using data directly from external memory; and
executing the layer at a reduced speed on the processing core.

6. The method of claim 1, wherein adaptations applicable to the layer are predetermined.

7. The method of claim 6, wherein the adaptation applicable to the layer are provided in context information associated with the ML model and wherein the determining that the adaptation may be applied is based on the context information.

8. A non-transitory program storage device comprising instructions stored thereon to cause one or more processors to:
receive a machine learning (ML) model, the ML model having one or more layers;
simulate executing a layer of the ML model on a target hardware without an adaptation applied to determine a first adaptation criterion;
simulate executing the layer of the ML model on the target hardware with the adaptation applied to determine a second adaptation criterion, wherein the adaptation reduces an amount of a resource used by the layer;
determine that the adaptation may be applied to the layer based on a comparison of the first adaptation criterion and the second adaptation criterion and an adaptation threshold; and
output an indication that the adaptation may be applied to the layer.

9. The non-transitory program storage device of claim 8, wherein the resource comprises one of an amount of memory, an amount of memory bandwidth, an amount of memory throughput, and an amount of current.

10. The non-transitory program storage device of claim 8, wherein the adaptation comprises at least one of:
altering a number of bits used to represent features of the layer;
altering a number of bits used to represent weights of the layer;
executing the layer on another processing core;
executing the layer using data directly from external memory; and
executing the layer at a reduced speed on a processing core of the one or more processors.

11. The non-transitory program storage device of claim 8, wherein the first adaptation criterion and the second adaptation criterion comprise an amount of time for executing the layer.

12. The non-transitory program storage device of claim 8, wherein the first adaptation criterion and the second adaptation criterion comprise output values of the layer.

13. The non-transitory program storage device of claim 8, wherein the first adaptation criterion and the second adaptation criterion comprise output values of the ML model.

14. The non-transitory program storage device of claim 8, wherein the instructions further cause the one or more processors to:
determine the amount of the resource will be used by the layer; and
determine the adaptation to apply for the simulated executing of the layer based on the determined amount.

15. An electronic device, comprising:
a memory; and
one or more processors operatively coupled to the memory, wherein the one or more processors are configured to execute instructions causing the one or more processors to:
receive an indication to execute a portion of a machine learning (ML) model on a processing core;
determine a resource allocation for executing the ML model on the processing core;
determine that a layer of the ML model will use a first amount of a resource that causes the resource allocation to be exceeded;
determine that an adaptation may be applied to executing the layer of the ML model;
execute the layer of the ML model using the adaptation, wherein executing the layer using the adaptation reduces the first amount of the resource used by the layer as compared to executing the layer without using the adaptation; and
output a result of the ML model based on the executed layer.

16. The device of claim 15, wherein the one or more processors configured to determine that the layer of the ML will use the first amount of the resource further cause the one or more processors to:
receive a request, from the processing core executing the ML model, for a dynamic allocation of a second amount of the resource; and
determine that there is an insufficient amount of the resource to allocate the second amount to the processing core.

17. The device of claim 16, wherein the resource is dynamically allocated to another executing ML model.

18. The device of claim 15, wherein the resource comprises one of an amount of memory, an amount of memory bandwidth, an amount of memory throughput, and an amount of current.

19. The device of claim 15, wherein the adaptation comprises at least one of:
altering a number of bits used to represent features of the layer;
altering a number of bits used to represent weights of the layer;
executing the layer on another processing core;
executing the layer using data directly from external memory; and
executing the layer at a reduced speed on the processing core.

20. The device of claim 15, wherein adaptations applicable to the layer are predetermined.
